(19) United States
(12) Patent Application Publication
(10) Pub. No.: US 2018/0270215 A1
(43) Pub. Date: Sep. 20, 2018

(54) PERSONAL ASSURANCE MESSAGE OVER SMS AND EMAIL TO PREVENT PHISHING ATTACKS

(71) Applicant: CA, Inc., New York, NY (US)

(72) Inventors: Ragavendran PADMANABHAN, Hyderabad (IN); Shaik MOKHINUDDEEN, Hyderabad (IN); Koti Reddy ALURI, Hyderabad (IN); Nelesh JAIN, Secunderabad (IN)

(73) Assignee: CA, Inc., New York, NY (US)

(21) Appl. No.: 15/460,464

(22) Filed: Mar. 16, 2017

(51) Int. Cl. H04L 29/06

(52) U.S. Cl. CPC H04L 63/083; H04L 51/04; H04L 63/1483; H04L 63/12

(57) ABSTRACT

A method includes, in response to receiving a request to authenticate a user, and retrieving a predefined security message created by the user and an indication of a preferred communication channel selected by the user, wherein the request to authenticate the user is sent to the server over a first communication channel that is different than the preferred communication channel. The method also includes transmitting, by the one or more processors and over the preferred communication channel, the predefined security message to a mobile device associated with the user for verification by the user. The method additionally includes authenticating the user using a secret password received from the user after transmitting the predefined security message.

### BACKGROUND

The present disclosure relates to the prevention of unauthorized access, and, more specifically, to systems and methods to authorize a user account using a registered personal assurance message.

Phishing is an attempt to obtain sensitive information such as usernames, passwords, and credit card details, often for malicious reasons, by masquerading as a trustworthy entity in an electronic communication. Phishing frequently exploits weaknesses in current web security. Phishing is often carried out by email spoofing or instant messaging, which direct users to enter personal information at a fake website with a look and feel almost identical to the legitimate original. Such emails and messages may be impersonating financial institutions, social media websites, online payment processors, and similar entities. Some phishing websites encourage users to enter username and password information thereby exposing the users to fraudulent use of their private accounts.

E-mail is a crucial tool in today's business world and phishing attacks have undermined users' trust of the system. However, attempts to control the growing number of phishing incidents have had limited success. Entities implement user training, public awareness, and technical security measures, but phishing attempts continue to be successful due to their ability to appear like the original legitimate website.

Systems and methods described herein may, upon receiving a username from a user, transmit a user-defined security message associated with the username to a separate user account in order for the user to confirm that the website is secure and is not a phishing attempt. Systems and methods described herein may transmit the user-defined security message via an SMS protocol to a mobile device associated with the user account. The present disclosure also describes systems and methods that may transmit the user-defined security message to a separate email account associated with the user account.

### BRIEF SUMMARY

According to an aspect of the present disclosure, a method may include in response to receiving, at a server, a request to authenticate a user, retrieving, by one or more processors of the server, a predefined security message created by the user and an indication of a preferred communication channel selected by the user, wherein the request to authenticate the user is sent to the server over a first communication channel that is different than the preferred communication channel; transmitting, by the one or more processors and over the preferred communication channel, the predefined security message to a mobile device associated with the user for verification by the user; and authenticating, by the one or more processors, the user using a secret password received from the user after transmitting the predefined security message.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements of a non-limiting embodiment of the present disclosure.

FIG. 1 is a schematic representation of an assurance system ecosystem in a non-limiting embodiment of the present disclosure.

FIG. 2 is a schematic representation of an assurance system configured to interact with the assurance system ecosystem.

FIG. 3 illustrates a flowchart describing functionality of an assurance system according to a non-limiting embodiment of the present disclosure.

FIG. 4 is a flow chart depicting authorization steps performed by an assurance system according to a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Each activity in the present disclosure may be executed on one, some, or all of one or more processors. In some non-limiting embodiments of the present disclosure, different activities may be executed on different processors.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to email systems, systems and methods disclosed herein may be related to any field involving correspondence or communication. Moreover, certain examples disclosed herein may be described with respect to consumer or business solutions, or any other field that may involve communication. Certain embodiments described in the present disclosure are merely provided as example implementations of the processes described herein.

Account based entities strive to provide users with useful protections against phishing attempts. However, users are often merely instructed to avoid providing unauthorized sources with username and password information. As a result, users are often preyed on by phishing schemes that closely resemble legitimate websites.

Systems and methods disclosed herein aim to reduce the chances of a successful phishing attack by confirming the legitimacy of a login portal. Systems and methods disclosed herein may receive a username associated with a user account during authentication of a user on a website. Systems and methods disclosed herein may further, in response to receiving the username, fetch a user-defined security message associated with the user account, the user-defined security message created by the user account prior to receiving the username during authentication of the user on the website. In addition, systems and methods disclosed herein may transmit, via an SMS protocol, the user-defined security message associated with the user account to a mobile device associated with the user account to indicate that the website is secure.

The teachings of the present disclosure may reference specific example “device.” For example, a “device” may refer to a smartphone, tablet, desktop computer, laptop, Global Positioning System (GPS) device, satellite communication terminal, radio communication terminal, or any other device capable of communications. For example, a mobile device may be equipped with an application capable of communicating with an email system. Any device with such capabilities is contemplated within the scope of the present disclosure.

In a first example, systems and methods disclosed herein may receive a username associated with a user account during authentication of a user on a website. In response to receiving the username, systems and methods disclosed herein may fetch, using one or more processors, a user-defined security message associated with the user account, the user-defined security message created by the user account prior to receiving the username during authentication of the user on the website. Systems and methods disclosed herein may transmit, via an SMS protocol, the user-defined security message associated with the user account to a mobile device associated with the user account to indicate that the website is secure.

In a second example, systems and methods disclosed herein may receive a username associated with a user account during authentication of a user on a website. In response to receiving the username, systems and methods disclosed herein may fetch, using one or more processors, a user-defined security message associated with the user account, the user-defined security message created by the user account prior to receiving the username. Systems and methods disclosed herein may transmit the user-defined security message associated with the user account to an email account associated with the user account to indicate that the website is not a phishing website.

In a third example, systems and methods disclosed herein may receive a username associated with a user account during authentication of a user on a website. In response to receiving the username, systems and methods disclosed herein may fetch, using one or more processors, a user-defined security message associated with the user account, the user-defined security message created by the user account prior to receiving the username during authentication of the user on the website. Systems and methods disclosed herein may transmit, via an SMS protocol, the user-defined security message associated with the user account to a mobile device associated with the user account to indicate that the website is secure. In addition, systems and methods disclosed herein may receive a password associated with the user account from the mobile device and send a refresh command to the website granting the user account authorized access upon receiving the password.

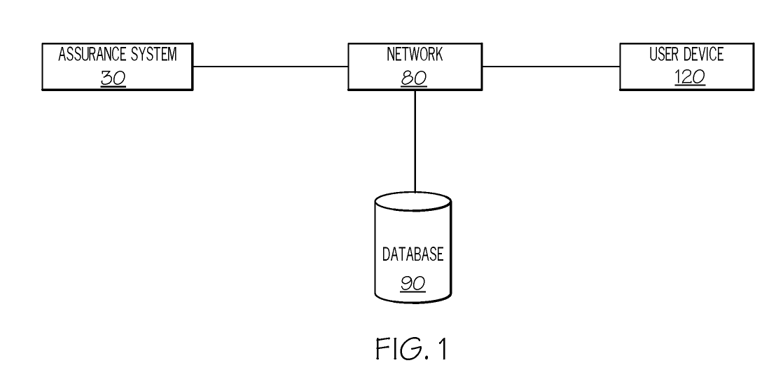

FIG. 1 is a schematic representation of an assurance system ecosystem in a non-limiting embodiment of the present disclosure. An assurance system 30 may communicate with a database 90 and user device 120 via a network 80. In some non-limiting embodiments of the present disclosure, assurance system 30 may directly communicate with user device 120 if assurance system 30 is installed on the user device 120. Further, assurance system 30 may communicate with a local database 95. User device 120 may be a mobile device with an email application capable of communicating with assurance system 30. In some non-limiting embodiments, assurance system 30 may be installed on the user device 120 as, for example, a plug-in. In some non-limiting embodiments, assurance system 30 may be a plug-in for an email application or a mobile application on a user's mobile device.

Network 80 may comprise one or more entities, which may be public, private, or community based. Network 80 may permit the exchange of information and services among users/entities that are connected to such network 80. In certain configurations, network 80 may be a local area network, such as an intranet. Further, network 80 may be a closed and/or private network/cloud in certain configurations, and an open network/cloud in other configurations. Network 80 may facilitate wired or wireless communications of information and provisioning of services among users that are connected to network 80.

Network 80 may comprise one or more clouds, which may be public clouds, private clouds, or community clouds. Each cloud may permit the exchange of information and the provisioning of services among devices and/or applications that are connected to such clouds. Network 80 may include a wide area network, such as the Internet; a local area network, such as an intranet; a cellular network, such as a network using CDMA, GSM, 3G, 4G, LTE, or other protocols; a machine-to-machine network, such as a network using the MQTT protocol; another type of network; or some combination of the aforementioned networks. Network 80 may be a closed, private network, an open network, or some combination thereof and may facilitate wired or wireless communications of information among devices and/or applications connected thereto.

Network 80 may include a plurality of devices, which may be physical devices, virtual devices (e.g., applications running on physical devices that function similarly to one or more physical device), or some combination thereof. The devices within network 80 may include, for example, one or more of general purpose computing devices, specialized computing devices, mobile devices, wired devices, wireless devices, passive devices, routers, switches, mainframe devices, monitoring devices, infrastructure devices, other devices configured to provide information to and/or receive information from service providers and users, and software implementations of such.

In some non-limiting embodiments of the present disclosure, user device 120 may be any type of computer such as, for example, a desktop computer. In other non-limiting embodiments, user device 120 may be a mobile device such as a mobile phone, laptop, tablet, any portable device, etc. Mobile electronic devices may be part of a communication network such as a local area network, wide area network, cellular network, the Internet, or any other suitable network. Mobile devices may be powered by a mobile operating system, such as Apple Inc.'s iOS® mobile operating system or Google Inc.'s Android® mobile operating system, for example. A mobile electronic device may use a communication network to communicate with other electronic devices, for example, to access remotely-stored data, access remote processing power, access remote displays, provide locally-stored data, provide local processing power, or provide access to local displays. For example, networks may provide communication paths and links to servers, which may host email applications, content, and services that may be accessed or utilized by users via mobile electronic devices. The content may include text, video data, audio data, user settings or other types of data. Networks may use any suitable communication protocol or technology to facilitate communication between mobile electronic devices, such as, for example, BLUETOOTH, IEEE WI-FI (802.11a/b/g/n/ac), or Transmission Control Protocol/Internet Protocol (TCP/IP).

In some non-limiting embodiments assurance system 30 may use network 80 to communicate with user device 120. In other non-limiting embodiments of the present disclosure, assurance system 30 may be installed on the user device 120. Assurance system 30 may be fully installed on the user device 120 and work in tandem with an email application on the user device 120. In some non-limiting embodiments of the present disclosure, assurance system 30 may support communications between the user device 120 and another device. In some non-limiting embodiments, user device 120 may represent a plurality of user devices such as, for example, laptops and mobile cellular telephones. In addition, a user may have a plurality of user accounts on each user device 120. Assurance system 30 may interact with any of a plurality of user accounts for each user.

The assurance system 30 environment may also include a database 90. Database 90 may include, for example, additional servers, data storage, and resources. Assurance system 30 may receive from database 90 additional data, user account information, user correspondence history and preferences, contact information, or any data used by assurance system 30. Database 90 may be any conventional database or data infrastructure. For example, database 90 may include scaled out data architectures (i.e., Apache Hadoop) and/or persistent, immutable stores/logging systems.

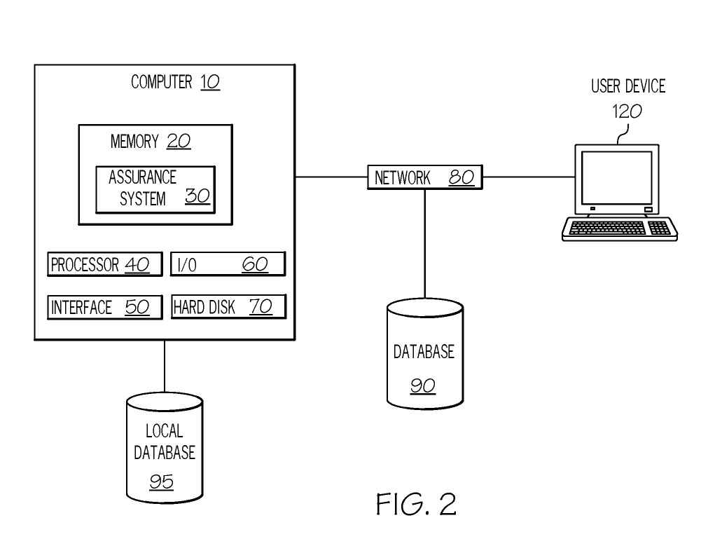

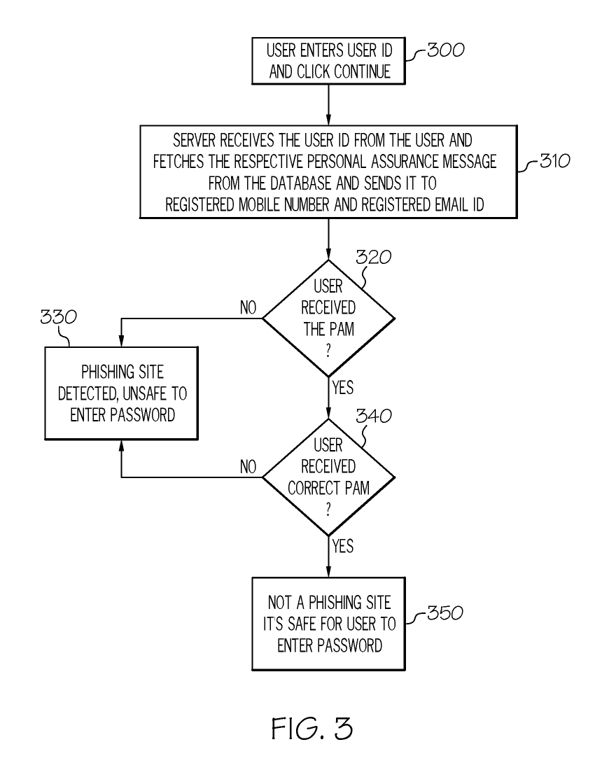

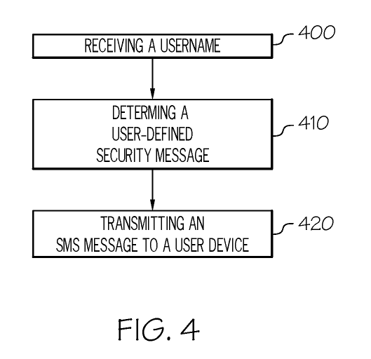

Referring to FIG. 2, the assurance system 30 of a non-limiting embodiment of the present disclosure is displayed. Computer 10 may reside on one or more networks. In some non-limiting embodiments, computer 10 may be located on any device that may receive input from a device, such as, for example, a mobile device or user device 120. Computer 10 may comprise a memory 20, a central processing unit, an input and output (“I/O”) device 60, a processor 40, an interface 50, and a hard disk 70. Memory 20 may store computer-readable instructions that may instruct computer 10 to perform certain processes. In particular, memory 20 may store a plurality of application programs that are under development. Memory 20 also may store a plurality of scripts that include one or more testing processes for evaluation of applications or input. When computer-readable instructions, such as an application program or a script, are executed by the CPU, the computer-readable instructions stored in memory 20 may instruct the CPU or assurance system 30 to perform a plurality of functions. Examples of such functions are described below with respect to FIGS. 3-4.

In some non-limiting embodiments of the present disclosure, the CPU may be assurance system 30. In some implementations, when computer-readable instructions, such as an application program or a script, are executed by the CPU, the computer-readable instructions stored in memory 20 may instruct the assurance system 30 to interact with user device 120. Computer 10 may be located on the user device 120, on a remote server, on the cloud, or any combination thereof. In some non-limiting embodiments, Computer 10 and assurance system 30 may communicate with user device 120 via network 80. In some non-limiting embodiments, assurance system 30 may interact with an email application on the computer 10 to communicate with other devices, such as user device 120. In some non-limiting embodiments, assurance system 30 may be located on the user device 120.

I/O device 60 may receive data from network 80, database 90, local database 95, data from other devices and sensors connected to assurance system 30, and input from a user and provide such information to the assurance system 30. I/O device 60 may transmit data to network 80, database 90, and/or local database 95. I/O device 60 may transmit data to other devices connected to assurance system 30, and may transmit information to a user (e.g., display the information, send an e-mail, make a sound) or transmit information formatted for display on a user device 120 or any other device associated with the user. Further, I/O device 60 may implement one or more of wireless and wired communication between user device 120 or assurance system 30 and other devices within or external to network 80. I/O device 60 may receive one or more of data from another server or a network 80. The assurance system 30 may be a processing system, a server, a plurality of servers, or any combination thereof. In addition, I/O device 60 may communicate received input or data from user device 120 to assurance system 30.

Assurance system 30 may be located on the cloud, on an external network, on user device 120, or any combination thereof. Assurance system 30 may be SaaS or entirely located on the user device 120. Furthermore, some non-limiting configurations of assurance system 30 may be located exclusively on a user device 120, such as, for example, a mobile device or tablet. Assurance system 30 may also be accessed and configured by a user on user device 120 or any other graphical user interface with access to assurance system 30. In some non-limiting embodiments, the user may connect to network 80 to access assurance system 30 using the user device 120.

Further referring to FIG. 2, in some non-limiting embodiments of the present disclosure, a mobile application may be installed on the user device 120. The mobile application may facilitate communication with assurance system 30, database 90, local database 95, an email application on user device 120, or any other entity. In some non-limiting embodiments, a program on user device 120 may track, record, and report input information to the assurance system 30, such as, for example, past interactions, login dates and times, user configurations, and corresponding data. In systems and methods of the present disclosure, such as when the assurance system 30 is located on user device 120, user device 120 may not be connected to network 80 while in communication with assurance system 30.

In some non-limiting embodiments, user device 120 may store data, user preferences and configurations, and any other data associated with the assurance system 30 locally on the user device 120. In some non-limiting embodiments of the present disclosure, an application on the user device 120 may communicate with assurance system 30 to manage communications, data, and corresponding user input or requests on the user device 120. User device 120 may have a user interface for the user to communicate with assurance system 30. An application on the user device 120 and assurance system 30 may maintain an offline copy of all information. In some non-limiting embodiments of the present disclosure, in which the assurance system 30 is located partially or completely on user device 120, assurance system 30 may facilitate communications regarding email communications with other devices. Assurance system 30 may also facilitate communications between users via SMS protocol, messaging applications on any device, or any other application used for communication. Assurance system 30 may rely on information stored locally on user device 120. User may store communication preferences on the user device 120. In some systems and methods of the present disclosure, assurance system 30 may rely on information such as user preferences and configurations in a cloud database.

FIG. 3 illustrates a flowchart describing functionality of an assurance system according to a non-limiting embodiment of the present disclosure. Assurance system 30 may, in some non-limiting embodiments, be associated with a website. In some non-limiting embodiments, a user may register a user ID or username along with a password on the website associated with assurance system 30. In some non-limiting embodiments, the password is a one-time password. In addition to login information, the user may designate a personal assurance message to associate with the account. In some non-limiting embodiments, the personal assurance message may be customized and extensive. The personal assurance message may also be as complicated as called for according to the relative security of the website. Further, the user may designate contact information and devices such as email addresses, mobile phone numbers, social media accounts, etc. Assurance system 30 may later use these accounts to authorize the identification of a user attempting to login to the created account.

In step 300, a user may enter a user ID or username for a user account on a website associated with assurance system 30. In step 310, a server associated with assurance system 30 may receive the user ID from the user and fetch a respective personal assurance message from database 90, local database 95, or a cloud database. In addition, assurance system 30 may send the personal assurance message to a registered mobile number or registered email address. In some non-limiting embodiments, assurance system 30 may send the personal assurance message to the registered mobile number via an SMS protocol.

In step 320, the assurance system may determine whether the user received the personal assurance message. The user may indicate on the respective receiving account that the personal assurance message is correct. If the user does not receive the correct personal assurance message, the website that appears legitimate may in fact be a phishing site and the user should not enter the corresponding password, as shown in step 330. If the user receives the correct personal assurance message, as seen in step 340, the website is not a phishing website and the user should confidently enter the corresponding password, as depicted in step 350.

Assurance system 30 may also track and store data regarding user communications. For example, assurance system 30 may track and store communications with a plurality of user devices. In some non-limiting embodiments, assurance system 30 may register a plurality of user devices for a single user account. Assurance system 30 may communicate with a user on any of the user devices associated with the user account. Data may be stored on local database 95, database 90, on computer 10, on user device 120, in the cloud, or in any other manner.

Assurance system 30 may determine whether a user device associated with a user account would be likely to receive a reply based on tracking, status, and/or activity data. For example, in some non-limiting embodiments, assurance system 30 may determine that a user has not been active on a user device associated with the user account for a predetermined amount of time. In some non-limiting embodiments where assurance system 30 determined which user account to communicate with a user, assurance system 30 may make communication decisions based on this information. In addition, assurance system 30 may determine the activity level of a user and adjust configured settings on the fly.

In some non-limiting embodiments, assurance system 30 may be able to determine the location of a user based on information on the user's device, such as, for example, the user's IP address. For example, assurance system 30 may not communicate with a user's mobile device associated with a user account due to a location of the mobile device determined by an IP address. Assurance system 30 may determine that the associated mobile device is in an unusual location and thus more likely to be missing or stolen.

FIG. 4 is a flow chart depicting authorization steps performed by an assurance system according to a non-limiting embodiment of the present disclosure. In step 400, a website associated with assurance system 30 may receive a username. In step 410, the assurance system may determine the user-defined security message created during registration of the account associated with the username. In step 420, assurance system 30 may transmit an SMS message to a user device associated with the user account. In some non-limiting embodiments, the assurance system 30 may transmit the personal assurance message to an external network. Upon receiving the personal assurance message, the user may be confident that the website is secure and not a phishing website. Upon receiving the personal assurance message, the user may enter the associated password in the website and gain access to the user account. If the user attempts to login to a phishing website masquerading as the legitimate website, the user will not receive a personal assurance message and thus should be aware that the site they are attempting to login to is not authentic. In some non-limiting embodiments, upon receiving the password, the assurance system 30 may send a refresh command to the website granting the user account authorized access. The password may be received by the assurance system 30 or on the website.

In some non-limiting embodiments, the user may receive a confirmation link along with the personal assurance message. The user may, instead of entering a password, click the link to gain access to the website. In this case, the website may authenticate the user using a parallel user account associated with the user's website account.

In some non-limiting embodiments, a user may create a different respective personal assurance message for a plurality of websites. In other non-limiting embodiments, a user may create one personal assurance message with the assurance system 30 and have the assurance system 30 apply this personal assurance message to each website with which the user associates or registers.

The assurance system 30 may enable the email application to perform actions automatically according to configurations of the sending user. In some non-limiting embodiments, the assurance system 30 may, upon meeting a condition set by the user, initiate a reminder notification to the user device receiving the personal assurance message, initiate a resending of the personal assurance message, or any other actions described in the present disclosure.

In some non-limiting embodiments, after receiving the personal assurance message, a user may respond with a password in the respective medium in which the message was received. For example, if the user receives the personal assurance message via SMS protocol on a user's mobile device, the user may respond via SMS protocol with the relevant password and be granted access to the relevant website. Upon receiving the correct password via SMS, the assurance system 30 may send a command to the website that the user is authorized and allow access to the respective secure account. The website may then allow the user access to the relative user account.

In some non-limiting embodiments, a user may also perform such an action in the email medium. For example, if the user receives the personal assurance message via email to an email address associated with the user account, the user may respond via email with the relevant password and be granted access to the relevant website. Upon receiving the correct password via email, the assurance system 30 may send a signal to the website that the user is authorized and should receive access to the respective secure account. The website may then allow the user access to the relative user account. In some non-limiting embodiments, a user may enter a password via a different medium than the medium receiving the personal assurance message. For example, a user may receive the personal assurance message via email and enter a password via an SMS message.

In some non-limiting embodiments, a user may receive a personal assurance message without attempting to login to a website associated with the assurance system 30. This may indicate that the user's username or login ID has been compromised and an unauthorized individual is attempting to login to the user's account. If receiving the personal assurance message via an SMS message, the SMS message may include a link to freeze the relevant account or block the account from further use. If receiving the personal assurance message via an email message, the email message may include a link to freeze the relevant account or block the account from further use.

The flowcharts and diagrams in FIGS. 1-4 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, “each” means “each and every” or “each of a subset of every,” unless context clearly indicates otherwise.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method, comprising:
in response to receiving, at a server, a request to authenticate a user, retrieving, by one or more processors of the server, a predefined security message created by the user and an indication of a preferred communication channel selected by the user, wherein the request to authenticate the user is sent to the server over a first communication channel that is different than the preferred communication channel;
transmitting, by the one or more processors and over the preferred communication channel, the predefined security message to a mobile device associated with the user for verification by the user; and
authenticating, by the one or more processors, the user using a secret password received from the user after transmitting the predefined security message.

2. The method of claim 1, wherein the secret password associated with the user account is received from the mobile device over the preferred communication channel.

3. The method of claim 1, wherein the user evaluates the propriety of a website associated with the server based on whether he or she receives the predefined security message.

4. The method of claim 1, further comprising transmitting the predefined security message to an email account associated with the user.

5. The method of claim 1, further comprising, in response to authenticating the user using the secret password, granting the user access to a website associated with the server.

6. The method of claim 1, wherein the preferred communication channel is an SMS communication channel.

7. The method of claim 1, further comprising transmitting a link to a secure log in page with the predefined security message over the preferred communication channel.

8. The method of claim 1, wherein the secret password is a one-time password.

9. A computer configured to access a storage device, the computer comprising:
a processor; and
a non-transitory, computer-readable storage medium storing computer-readable instructions that when executed by the processor cause the computer to perform:
in response to receiving, at a server, a request to authenticate a user, retrieving, by one or more processors of the server, a predefined security message created by the user and an indication of a preferred communication channel selected by the user, wherein the request to authenticate the user is sent to the server over a first communication channel that is different than the preferred communication channel;
transmitting, by the one or more processors and over the preferred communication channel, the predefined security message to a mobile device associated with the user for verification by the user; and
authenticating, by the one or more processors, the user using a secret password received from the user after transmitting the predefined security message.

10. The computer of claim 9, wherein the secret password associated with the user account is received from the mobile device over the preferred communication channel.

11. The computer of claim 9, wherein the user evaluates the propriety of a website associated with the server based on whether he or she receives the predefined security message.

12. The computer of claim 9, further comprising transmitting the predefined security message to an email account associated with the user.

13. The computer of claim 9, further comprising, in response to authenticating the user using the secret password, granting the user access to a website associated with the server.

14. The computer of claim 9, wherein the preferred communication channel is an SMS communication channel.

15. The computer of claim 9, further comprising transmitting a link to a secure log in page with the predefined security message over the preferred communication channel.

16. The computer of claim 9, wherein the secret password is a one-time password.

17. A non-transitory computer-readable medium having instructions stored thereon that are executable by a computing system to perform operations comprising:
in response to receiving, at a server, a request to authenticate a user, retrieving, by one or more processors of the server, a predefined security message created by the user and an indication of a preferred communication channel selected by the user, wherein the request to authenticate the user is sent to the server over a first communication channel that is different than the preferred communication channel;
transmitting, by the one or more processors and over the preferred communication channel, the predefined security message to a mobile device associated with the user for verification by the user; and
authenticating, by the one or more processors, the user using a secret password received from the user after transmitting the predefined security message.

18. The computer-readable medium of claim 17, wherein the secret password associated with the user account is received from the mobile device over the preferred communication channel.

19. The computer-readable medium of claim 17, wherein the user evaluates the propriety of a website associated with the server based on whether he or she receives the predefined security message.

20. The computer-readable medium of claim 17, further comprising transmitting the predefined security message to an email account associated with the user.
